(19) United States
(12) Patent Application Publication
(10) Pub. No.: US 2007/0109098 A1
(43) Pub. Date: May 17, 2007

(54) System for providing network access security

(76) Inventors: John A. Siemon, Woodbury, CT (US); Carrie Higbie, Ridgeland, MS (US)

Correspondence Address: CANTOR COLBURN, LLP, 55 GRIFFIN ROAD SOUTH, BLOOMFIELD, CT, 06002, US

(21) Appl. No.: 11/493,332

(22) Filed: Jul. 26, 2006

Related U.S. Application Data
(60) Provisional application No. 60/702,763, filed on Jul. 27, 2005.

(51) Int. Cl. H04Q 5/22

(52) U.S. Cl. 340/10.1; 340/10.42; 340/5.8

(57) ABSTRACT

A system for controlling access to a network, the system comprising: a network access point; an identity reader associated with the network access point, the identity reader receiving an identity of a user attempting to access the network at the network access point; a security controller for receiving the identity of the user and determining if the user is authorized to access the network; a network switch coupled to the network access point, the network switch enabling the network access point if the user is authorized to access the network, the network switch disabling the network access point if the user is not authorized to access the network.

### CROSS-REFERENCE TO RELATED APPLICATIONS

This application claims the benefit of U.S. provisional patent application, Ser. No. 60/702,763 filed Jul. 27, 2005, the entire contents of which are incorporated herein by reference.

### BACKGROUND

Network security is a common issue as networks become more widespread. There exist a number of software-based solutions for preventing user access to a network such as using login IDs/passwords, encryption, public/private keys, SSL, etc. While these solutions prevent virtual access to network resources, there is a need in the art to prevent unauthorized physical access to networks.

### SUMMARY

Embodiments of the invention include a system for controlling access to a network, the system comprising: a network access point; an identity reader associated with the network access point, the identity reader receiving an identity of a user attempting to access the network at the network access point; a security controller for receiving the identity of the user and determining if the user is authorized to access the network; a network switch coupled to the network access point, the network switch enabling the network access point if the user is authorized to access the network, the network switch disabling the network access point if the user is not authorized to access the network.

### BRIEF DESCRIPTION OF THE DRAWINGS

FIG. 1 is a network diagram showing outlets associated with an identity reader.

FIG. 2 shows a personal computer coupled to an outlet incorporating an identity reader.

FIG. 3 shows a faceplate having outlets and an incorporated identity reader.

### DETAILED DESCRIPTION

Embodiments of the invention relate to a cabling network that provides logical linkage between a personal identity reader and network (e.g., LAN) access points such as wireless access points (WAPs) or wired outlets. This logical linkage ensures that only authorized personnel can activate LAN access points. The identity reader can be any device that can authenticate identity of a user, including card readers or biometric readers.

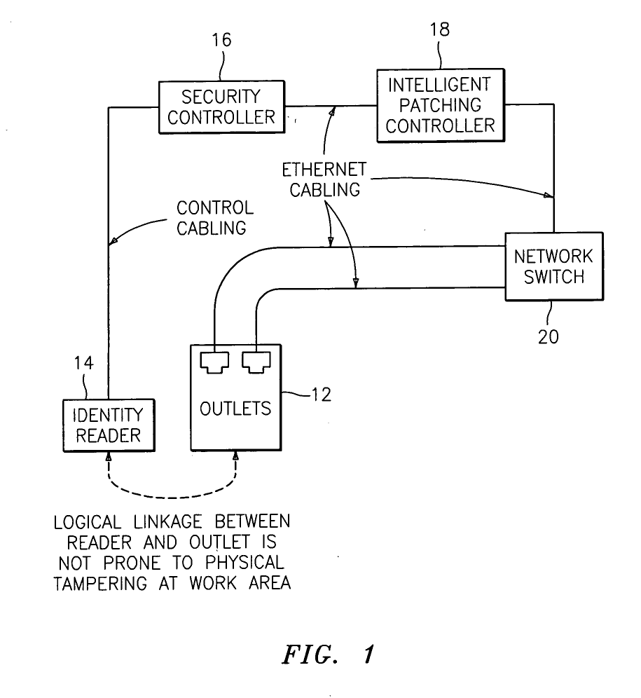

FIG. 1 is a network diagram showing outlets 12 associated with an identity reader 14. Embodiments of the invention are described with reference to outlets, but it is understood that other network access points may be employed, such as wireless access points. A user accesses the identity reader 14 through a card (e.g., magnetic card), biometric input (e.g., voice, fingerprint), RFID tag, numerical PIN pad, etc. to verify the user identity. The identity reader 14 is logically associated with on or more outlets 12 (e.g., through a database corresponding identity readers with outlets).

The user identity is provided to a security controller 16 that determines if the user is authorized to access the outlet. If the security controller determines that the user is authorized to access the outlets, a signal is sent to an intelligent patching controller 18. The intelligent patching controller 18 commands a network switch 20 to establish a connection between the network and the outlets 12 enabling the user to gain access to a LAN. The network switch 20 knows which outlets 12 to connect to the network based on the logical mapping of the identify reader 14 to one or more outlets 12. If the security controller 16 does not authorize the user, then the outlets 12 remain isolated from the network. An indicator (e.g., LED, speaker, etc.) may be activated to indicate a grant or denial of access.

In other embodiments, a work area faceplate mechanically integrates an identity reader with LAN outlet faceplate. FIG. 3 shows a faceplate 30 having outlets 12 and an incorporated identity reader 14. For example, embodiments allow an access card reader 14 to be incorporated into a faceplate fitted with RJ45 outlets, TERA brand connectors from The Siemon Company, fiber connectors, etc. The faceplate 30 may utilize PoE (IEEE 802.3af) for power. Incorporated into the faceplate 30 is an identity reader 14 such as an access card reader. The identity reader 14 either activates the port 12 or assures that the port 12 cannot communicate based on the authentication from the access card that is swiped through the faceplate 30. It is understood that other types of identity readers may be used, and embodiments are not limited to card-based readers.

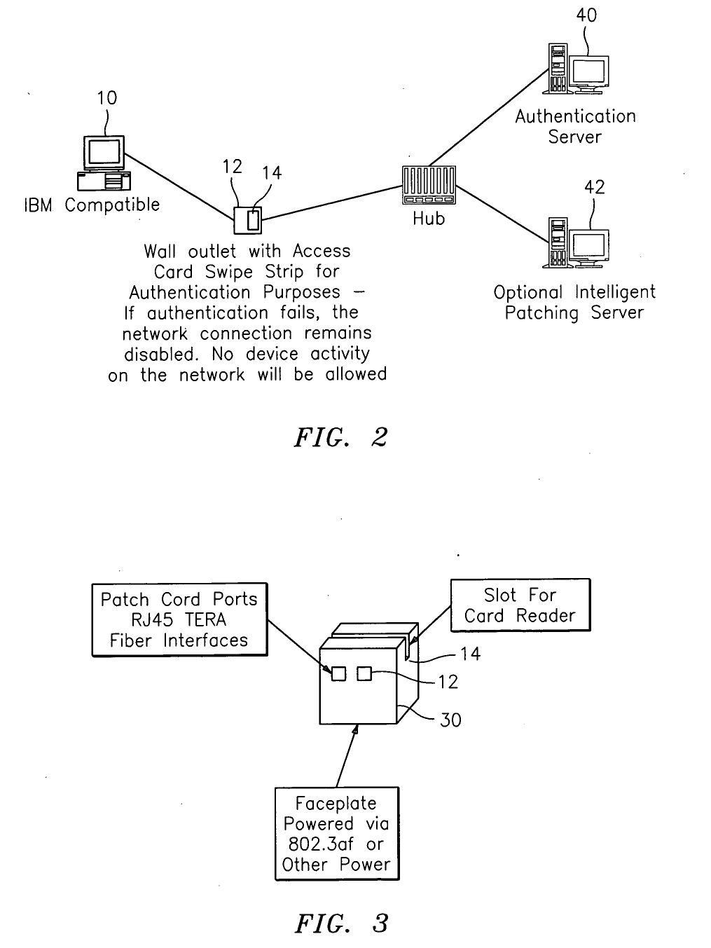

FIG. 2 shows a personal computer 10 coupled to an outlet 12 incorporating an identity reader 14. As noted above, the identity reader 14 on the outlet 12 may obtain identity through a card, biometrics, RFID, etc. The user identity is provided to an authentication server 40. If the user identity is verified, then an intelligent patching server 42 connects the outlets 12 to a network. If the user identity is not verified, then the outlet 12 remains disconnected from the network.

The combination faceplate with identity reader allows for security at the physical layer. This secures networks above and beyond utilizing active equipment for security. Not all active equipment is under the control of the local security team. By blocking network access at the physical layer, this security measure provides greater protection and protection against machines attaching to the network that may or may not be under local security control.

The faceplate with identity reader may be attached to an intelligent patching system where the identity of the person seeking network access can be logged and tracked. If proper access is not authenticated, the outlets remain disabled thereby restricting access to the network at the physical layer. In other embodiments, the identity reader is not mechanically incorporated in the faceplate, but connected via a cable to the LAN faceplate. This embodiment provides easier user access to the identity reader if the LAN faceplate is in a hard-to-reach location.

Embodiments of the invention add an additional layer of security above and beyond merely tracking access and/or allowing access to a computing device. The outlets are connected and controlled through a secure server and until authentication is achieved, the network connection will remain disabled. Network connections are tracked through the secure authentication server and/or intelligent patching controller to provide an audit log for all connections that become active after proper authentication. The connection will time out after a period of 20 minutes (or other time frame as necessary) of inactivity conforming to HIPAA and other applicable standards and legislation governing security in the US and other countries. Various encryption algorithms will be supported based US export laws. Supported physical connections include TERA brand connectors available from The Siemon Company, (selected for its low tempest emissions), UTP with an RJ45 interface and fiber. Embodiments of the invention answer many security concerns for outlets in open areas, outlets in medical facilities, and outlets in any area where security is a prime concern.

Controlling access via access cards attached to a computing device (e.g., a personal computer) falls short of blocking all network connections as the computing device would need to be under the control of the local security authority. Outlets exist in conference rooms and empty offices providing another point of ingress into a network. By controlling the actual network connection at the outlet, a far superior level of protection is provided and additional protection is provided against unwanted computing devices attaching to the network at any physical location.

Benefits extend to both the public and private sectors through a secure physical layer system. Full audit logging and security tracking exists for any outlet that becomes active as well as any port that has a failed attempt which may be considered a breech. The ability to control access at the physical connection rather than the device provides a layer of security that has not been available to date. Commercially, embodiments of the invention answer a need to control network access by disabling all ports until access is granted by assuring that traffic cannot travel the network cable thereby preventing snooping and other unwanted network traffic.

Components include a faceplate with an incorporated access identity reader and a connection for a patch cord of the proper media (TERA, RJ45, Fiber). One cable is utilized to power the outlet via 802.3af or other acceptable power sources. The faceplate can be fitted with one or two connections based on need. The identity reader may be incorporated into the faceplate and in communication with the security controller. When a user needs access to the network, he will swipe the appropriate card through the reader. The information is transmitted to a secure server that will provide authentication. When the authentication is successful, the port will be activated and the user's information will be stored in the access log. If authentication is not successful, the failed attempt will be logged and port will remain inactive.

The identity reader may also be separate from the faceplate and in communication with the security controller via a cable as shown in FIG. 1. If the identity reader is not in communication with the security controller, the port may be disabled by default. If the identity reader is attached but authentication has not occurred or it has timed out, the port will remain inactive.

As described above, embodiments provided access control to a network from access points, including wired outlets or wireless access points. Thus, embodiments of the invention are not limited certain outlet form factors, but rather any network access point.

While this invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A system for controlling access to a network, the system comprising:
a network access point;
an identity reader associated with the network access point, the identity reader receiving an identity of a user attempting to access the network at the network access point;
a security controller for receiving the identity of the user and determining if the user is authorized to access the network;
a network switch coupled to the network access point, the network switch enabling the network access point if the user is authorized to access the network, the network switch disabling the network access point if the user is not authorized to access the network.

2. The system of claim 1 further comprising:
an intelligent patching controller receiving authorization from the security controller to enable network access for the user, the intelligent patching controller commanding the network switch to enable access to one or more network access points.

3. The system of claim 1 wherein the network access point is a wall outlet.

4. The system of claim 1 wherein network access point is a wireless access point.

5. The system of claim 1 wherein the identity reader is a card reader.

6. The system of claim 1 wherein identity reader is biometric reader.

7. The system of claim 1 wherein identity reader is an RFID reader.

8. The system of claim 3 wherein the identity reader is integrated with a faceplate surrounding the outlet.

9. The system of claim 2 wherein the intelligent patching controller logs user identities attempting to access the network.

10. The system of claim 1 wherein the network switch disables the network access point after a period of inactivity at the network access point.

11. The system of claim 1 wherein if the identity reader is not in communication with the security controller, the network switch disables network access for the network access point.
